(19) United States
(12) Patent Application Publication
(10) Pub. No.: US 2014/0222833 A1
(43) Pub. Date: Aug. 7, 2014

(54) Trusted Social Networks

(71) Applicant: Trusper, Inc., Los Altos Hills, CA (US)

(72) Inventors: Jack Shilian Jia, Los Altos Hills, CA (US); Robert David Bradshaw, JR., San Jose, CA (US); Yan Carrie Jiao, Beijing (CN); Yuwei Gui, Mountain View, CA (US); Scott Brenner Brave, Louisville, CO (US)

(73) Assignee: Trusper, Inc., Los Altos Hills, CA (US)

(21) Appl. No.: 14/078,393

(22) Filed: Nov. 12, 2013

Related U.S. Application Data
(60) Provisional application No. 61/724,877, filed on Nov. 9, 2012.

(51) Int. Cl. G06F 17/30

(52) U.S. Cl. CPC G06F 17/3053
USPC 707/748

(57) ABSTRACT

The present invention extends to methods, systems, and computer program products for trusted social networking. Embodiments of the invention include a trusted social network that adds value by sharing information that is both of interest to a user (e.g., based on needs, preferences, and time and place) and is from trusted sources (e.g., friends). Tips associated with the trusted social network can be created (as well as presented) and viewed through a client program that provides an interface to the trusted social network. In some embodiments, the client program is used to present the user interface and handle interactions with the trusted social network. In other embodiments, web based constructs are used to present the user interface and handle interactions with the trusted social network through a web browser.

### CROSS-REFERENCE TO RELATED APPLICATIONS

This application claims the benefit of U.S. Provisional Patent Application No. 61/724,877, entitled “Trusted Social Networks”, filed Nov. 9, 2012, by Jack Jia et al., which is incorporated herein in its entirety.

### BACKGROUND

1. Field of the Invention

This invention relates generally to the field of social networking, and, more particularly, to trusted social networks.

2. Related Art

Social networks can vary in providing information that is of interest to a user. Social networks can also vary in the level of trust between users that is required to provide information to one another.

Some social networks provide information that is of interest to a user but do not require users to have any established relationship between one another. For example, for sale sites or recommendation sites can provide information to a general population of users. A user can access the social network site to find information that is of interest. However, if an item or recommendation listing is from or associated with a total stranger, a user may be less willing to engage with and/or trust the listing. For example, a recommendation for a cement contractor may be of little value if the recommendation is provided by a total stranger.

Some social networks require an established level of trust between users before information can be exchanged. For example, two users may have to mutually declare “friendship” before they can see one another's information and postings. However, establishing a trust level with another user does not mean that one user is necessarily interested in all of another user's information and postings. For example, one user may become “friends” with another user due to a mutual interest in golf. However, becoming friends does not necessarily indicate that the user has general interest in information and postings from the other user. Nonetheless, once a trust relationship is established, all information and postings from the other user may be available to (and may even be somewhat forced upon) the user. For example, the user may have no interest in work related or politics related information from the other user. However, the user may have to wade through this information as it is intermingled with golf related information from the other user.

### BRIEF DESCRIPTION OF THE DRAWINGS

The specific features, aspects and advantages of the present invention will become better understood with regard to the following description and accompanying drawings where:

FIG. 1A illustrates an example computer architecture that facilitates trusted social networks.

FIG. 1B illustrates an example computer architecture that facilitates matching items to users.

FIG. 2 illustrates a flow chart of an example method for matching items to users.

FIG. 3 depicts screenshot examples of exploring tips and topics and viewing a tip.

FIG. 4 illustrates an example computer architecture that facilitates using deep links to select destination content.

FIG. 5 illustrates a flow chart of an example method for using a deep link to select destination content.

FIG. 6 illustrates an example computer architecture that facilitates a four tier caching system

FIGS. 7A-7D depicts an example of offer products for sale through a tip.

FIGS. 7E and 7F depict an example of virtual goods.

FIGS. 8A-8E depicts different status levels and corresponding promotional tools.

FIG. 9 depicts a data flow for a market place of tips.

FIG. 10 depicts a data flow for a market place of tips.

FIGS. 11A-11D depicts user interface for helping out with a tip.

FIG. 12 depicts user-interface screen shots of for hire and help wanted ads.

FIG. 13 depicts user-interface screen shots of one click adding of a friend based on geographic proximity.

FIG. 14 depicts user-interface screen shots of tip creation.

FIG. 15 depicts user-interface screen shots of viewing a tip, information and tip talk.

FIG. 16 depicts user-interface screen shots of deal, coupon, and following.

FIG. 17 depicts user-interface screen shots of a punch card and other integrations.

FIG. 18 depicts user-interface screen shots of related tips, sponsored ads, and features.

FIG. 19 depicts user-interface screen shots of favorites and profile information.

### DETAILED DESCRIPTION

The present invention extends to methods, systems, and computer program products for trusted social networks.

Embodiments of the invention include a trusted social network that adds value by sharing information that is both of interest to a user (e.g., based on needs, preferences, and time and place) and is from trusted sources (e.g., friends). Shared information can relate to life tips, including tips on: food and drink, home and garden, travel, fashion and beauty, entertainment, family, sports, auto, arts, education, pets, offers and deals, for hire, help wanted, etc. Tips associated with the trusted social network can be created (as well as presented) through a program that provides an interface to the trusted social network.

A client program can provide a user-interface for a user to submit tips to and view tips from the trusted social network. The client program can be run on a computing device, such as, a mobile phone. In some embodiments, the application program (or “app”) is used to present the user interface and handle interactions with the trusted social network. In other embodiments, web based constructs are used to present the user interface and handle interactions with the trusted social network through a web browser.

Tips can include videos, pictures, audio and notes about knowhow and information on daily needs. Tips can vary in scope and can be shared among trusted friends and service professionals. Tips can be for friends, can be self-tips, or can be public-tips. In some embodiments, tips can be created in a short amount of time (e.g., 30 seconds-5 minutes). Tips can include advice from one user to another, such as, for example, a solution or suggestion for a problem a user is experiencing.

In general, anyone can sign up to be a member of a trusted social network. Consumer members can use the trusted social network to 1) store their personal and private tips for future reference, 2) share their life learning/tidbits with their friends, and 3) publish their proud moments/knowledge to the public. Business members can use the trusted social network to connect with their customers, promote their services (offers, coupons, deals etc.). Both consumers and businesses can use the system to hire professionals or employees for projects or jobs.

Members can earn points of achievement by performing good deeds such as publishing “well-liked” tips, sharing good tips to other social networks, inviting friends to join Trusper etc.

Promotional tips can be presented to users either in Sponsored Tips in any category, or in the category of promotions such as “Offers & Deals”, “For Hire”, “Help Wanted”, etc. These tips can be ranked (and matched) by popularity, location and a user's social interests to them. For example, if a friend of mine Joe likes a coupon from a restaurant, the coupon can be ranked higher to me than to someone who is not a friend of Joe. As a result, matching engine 101 can promote ads without offending users.

Businesses also get exposure of their offers/tips by having friends to push their tips at the right place and right time, or by having a large set of followers. In addition, businesses can buy ad placement in related tips or popular tips. Through ad bid system 103, business can bid with each other on the pricing of certain spots. Ad bid system 103 can be contextual and friends driver helping businesses and services between promote themselves.

Special tip templates can be created for business purpose. The templates allow business owners to create business Tips very quickly and in real-time to promote their business. For example, an “Offers and Deals” tip can allows consumers to pass around the tip by reposting and sharing them (via the App, Facebook, Email, SMS etc.). A “redeem” button can be built in to allow consumers to follow the business in the future.

Similar templates can be used to support “For Hire” and “Help Wanted” tips. Service professionals like gardeners, pool man, etc. can get referrals directly from their existing customers. Bars and restaurants can post their jobs with tips and get applicants directly via video and pictures on the candidates instead of a form or resume.

A user application for a trusted social network can use GPS to locate and connect friends nearby. This is a relatively quick way to connect with friends beyond the traditional connections via Facebook, Email, Contact List etc.

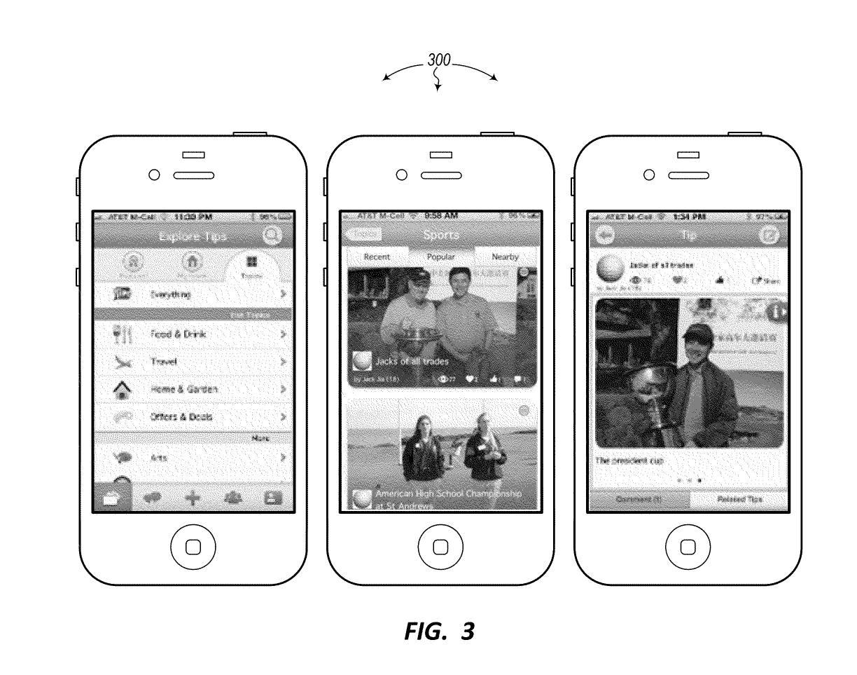

FIG. 3 depicts screenshot examples 300 of exploring tips and topics and viewing a tip. As shown, the “folders” icon in the bottom left is selected.

In the following description of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Devices can have touch screens as well as other I/O components.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

System Architecture

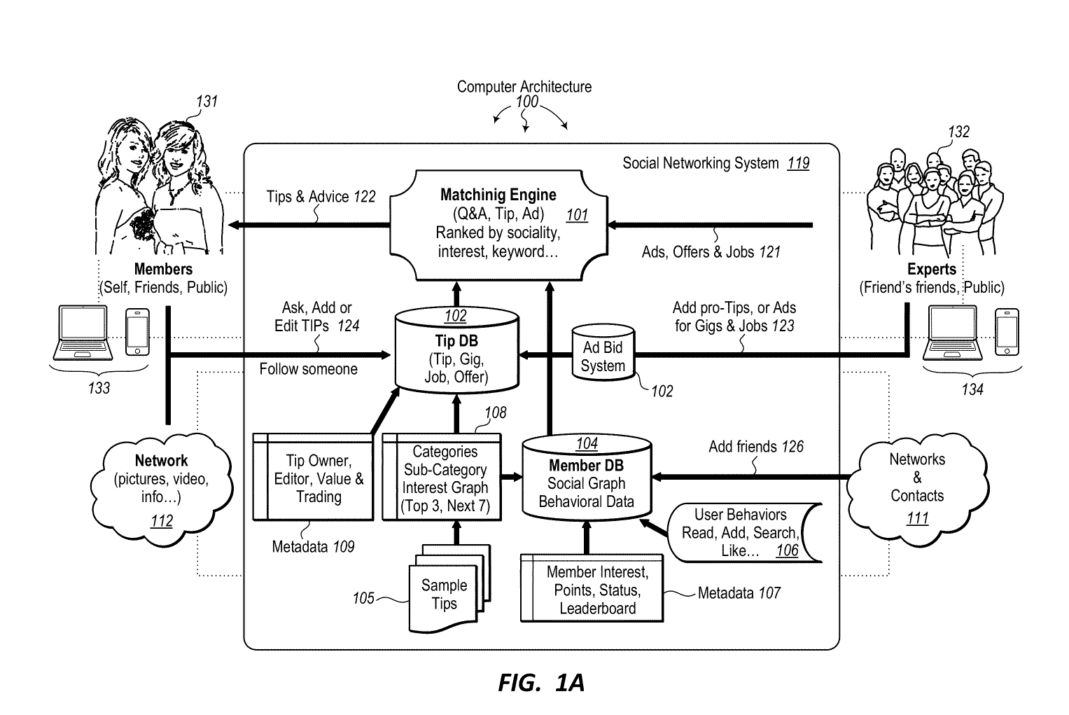

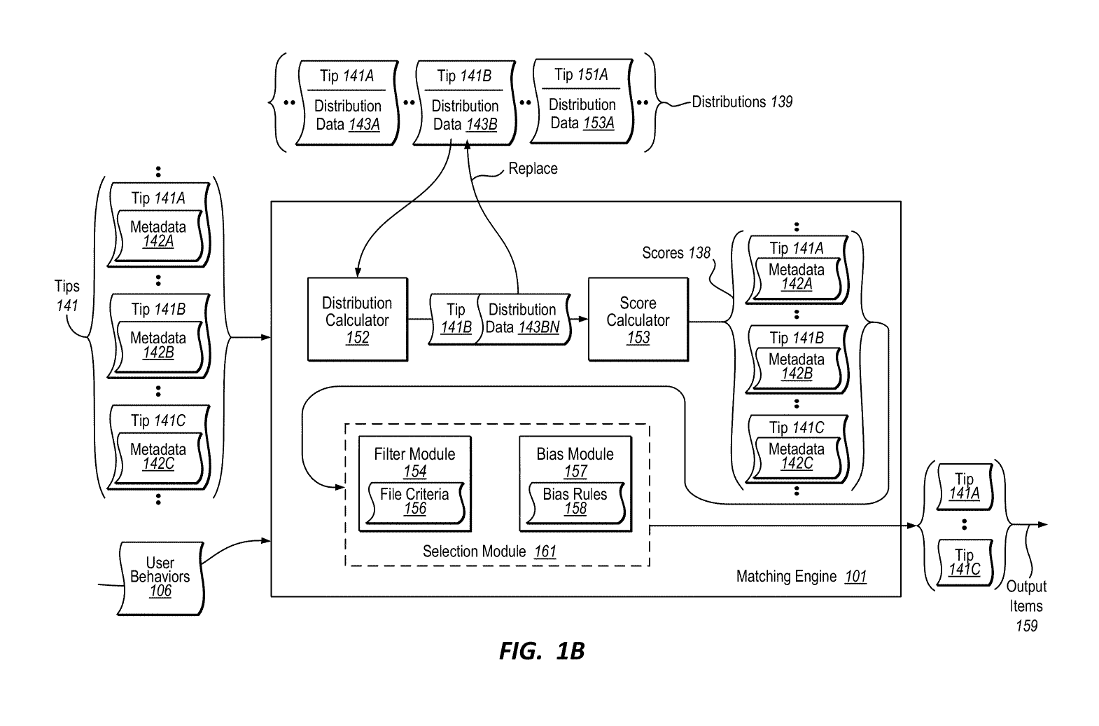

FIG. 1A depicts an example computer architecture 100 for a trusted social network. As depicted, computer architecture 100 includes social networking system 119, devices 133, devices 134, network 112, and networks and contacts 111. Social networking system 119 further includes matching engine 101, tip database 102, ad bid system 103, and member database 104. Matching engine 101 can be used to match ads, offers, and jobs to tips and advice to provide to friends. Matching engine 101 can consider input from the tip database 102 and input from the member database 104 when matching ads, offers, and jobs to tips and advice for a user.

Experts 132 (or even just basic users) can use an application on their computer or phone 134 to post ads, offers, pro-tips, and jobs 121 which matching engine 101 can be attempt to match to members 131 of the trusted social network. Experts 132 (or even just basic users) can also submit ads 123 to the ad bid system 103.

Tips in tip database 102 can be associated with various types of metadata 109 including a tip owner, a tip editor, a value, etc. Tips in tip database 102 can also be categorized into categories 108 of interest, sub-categories of interest, etc. Tips can be categorized from samples tips 105. Sample tips 105 can be used as templates for actual tips.

Members 131 in member database 104 can also be associated with various types of metadata 107 including member interest, categories of interest, sub-categories of interest, points, status, leader board, and user behavior 106 with respect to tips, such as, for example, read, add, search, and like. Members 131 can be added to the member database 104 from other social networks and contact lists 111.

Members 131 can use an application on their computer or phone 133 to create and edit tips as well as view tips from other members 131. Members 131 can also use an application to invite other members to be friends and to follow other members 131.

In general, a tip is a generic informational unit that users create, store, share, use and search for. A tip can include a list of media assets (photos, video, audio and other media types), textual/audio/music captions about the media assets, a list of reference info and contact info. Users can use a smart phone, pad or PC to create these tips quickly (typically within a few minutes). As described, tips can be stored in the tip database (e.g., in the cloud) for reuse, sharing and archiving. Tips can include advice or solutions to problems or situations a tip creator has encountered. Tips can also include information a tip creator found useful and would like to share with other users. Other users can refer to tips for assistance or information.

Tips can be organized into different “Topics” including Arts, Auto, Business, Entertainment, Family, Fashion & Beauty, Food & Drink, For Hire, Games, Help Wanted, Home & Garden, Offers & Deals, Pets, Sports, Technology, Travel, as well as individually defined categories and “Everything”. Each Topic is made of a list of “Interests”. For example, “Sports” is made of “Football”, “Golf”, “Tennis”, “Baseball” and others. Topics are also called Categories and Interests are also referred to as Sub-Categories. Categories 108 can contain a much larger set of categories/sub-category keywords than what members see. If members have preferences on certain keywords or terms, these keywords can become more visible to users, and less used keywords can be suppressed.

A trusted social network can generate a social graph that is ultimately more interesting because it is based on the “Word of Actions” and frequent usage (daily or weekly). The social graph together with a unique interests graph helps to make the trusted social network more effective in serving content and promotions in the form of tips.

User behaviors can be tracked in a trusted social network including both express and implicit behaviors. Explicit behaviors include rating, liking, commenting, sharing, reposting, saving, etc. Implicit behaviors include clicking, viewing, swiping, enlarging, dwell time, flipping to the backside, viewing comments, viewing related/popular/nearby/ . . . , calling, mapping, emailing, chatting, geo-location, etc. By combining these behaviors and the categories/topics/interests, individual user interests graph can be derived for members. By correlating multiple users' interests graph, peer interests graphs or crowd interest graphs can be generated. The interest graph is further used to target the right content/tips to right users therefore achieve high levels of personalization.

By factoring both social graph and interests graphs of members, the trusted social network can predict (relatively accurately) the content/tips that members would like to consume at a given moment. Related tips are displayed to members by weighing social norms, contexts, location and historical interests. Matching engine 101 can dynamically weigh in these factors and changes the outcome what users see. Matching engine 101 can observe, learn and adapt.

Tip Matching

Tips (or other items) matched to a member can be optimized to increase the likelihood of the member being satisfied with the tips. Any of a variety of different algorithms can be used to match tips (or other items) to a member. Statistical techniques can be used to select a set of tips (or other items) for presentation to a member based on the computer quality of each tip (or other item). For example, greedy approaches, eplison-greedy approaches, and Bayesian bandit approaches can be used match tips to a member. Additional other statistical approaches can also be used.

FIG. 1B illustrates an example computer architecture that facilitates matching items to users. As depicted in FIG. 1B, matching engine 101 further includes distribution calculator 152, score calculator 153, and selection module 161. Selection module 161 further includes filter module 154 and bias module 157. The modules of matching engine 101 can interoperate to match items to users.

Distributions 139 contain distribution data for one or more tips. For example, distributions 139 contain distribution data 143A, 143B, and 153A for tips 141A, 141B, and 151A respectively. Distribution data for a tip represents a distribution for a quality belief curve for the tip. Distribution data can be based on data from similar tips as well as user behavior related to the tip. A quality belief curve for a tip can be a graph of percentages of percentages indicating how likely the tip is to be viewed as satisfactory (e.g., liked) by a user. For example, one point on the quality belief curve can indicate with 50% certainty that 80% of users will find a tip satisfactory. Another point on the quality belief curve can indicate with 10% certainty that 20% of users will find the tip satisfactory. A further point on the quality belief curve can indicate with 10% certainty that 90% of users will find a tip satisfactory. Percentages (both certainty and results) can be updated as more information because available.

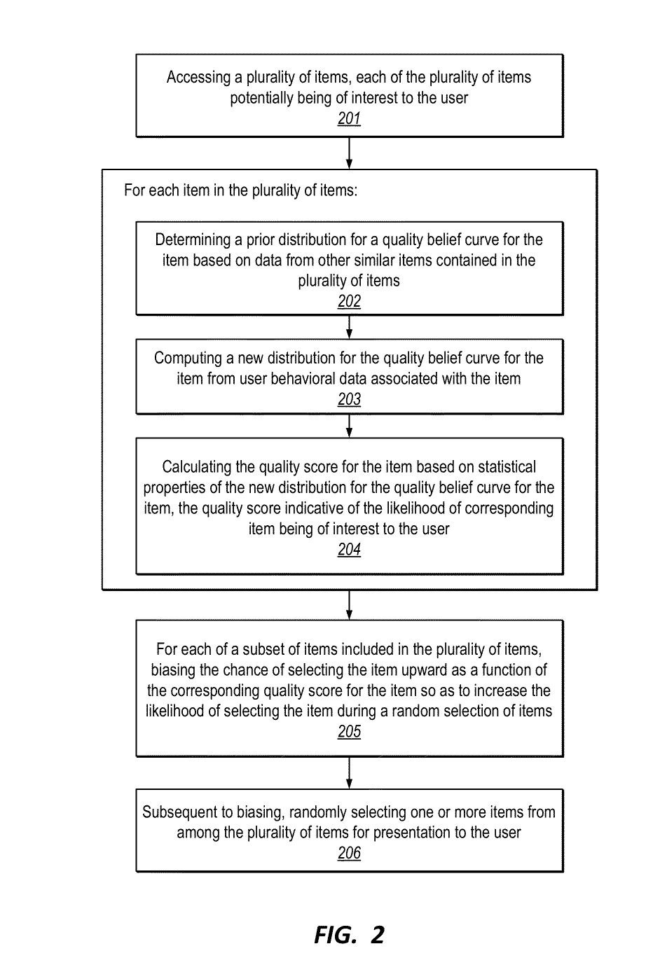

FIG. 2 illustrates a flow chart of an example method for matching items to users. Method 200 will be described with respect to the components and data in FIG. 1B.

Method 200 includes an act of accessing a plurality of items, each of the plurality of items potentially being of interest to a user (201). For example, matching engine 101 can access tips 141 (e.g., from tip DB 102). As described, each tip can include content as well as metadata. For example, tips 141A, 141B, and 141C include metadata 142A, 142B, and 142C respectively. Metadata can include an author, a topic, a time stamp (e.g., indicating a creation time), etc.

For each item in the plurality of items, method 200 includes determining a prior distribution for a quality belief curve for the item based on data from other similar items contained in the plurality of items (202). For example, distribution calculator 152 can access distribution data 143B for tip 141B. Distribution data 143B can represent a distribution for the quality belief curve for tip 141B. As such, distribution calculator 152 can calculate a quality belief curve distribution for tip 141B from distribution data 143B. Distribution data from other tips (e.g., distribution data 153A) can also be considered.

For each item in the plurality of items, method 200 includes computing a new distribution for the quality belief curve for the item from user behavioral data associated with the item (203). For example, distribution calculator 152 can calculate distribution data 143BN for tip 141B from user behaviors 106 (opens, likes, reads, comments, etc.) associated with to tip 141B. Distribution data 143BN can represent a new distribution for the quality belief curve for tip 141B. As such, distribution calculator 152 can calculate a new quality belief curve distribution for tip 141B from distribution data 143BN. Distribution data 143BN can also be used to replace distribution data 143B in distributions 139.

For each item in the plurality of items, method 200 calculating the quality score for the item based on statistical properties of the new distribution for the quality belief curve for the item, the quality score indicative of a likelihood of a corresponding item being of interest to the user (204). For example, score calculator 153 can calculate quality score 144B for tip 141B based on the statistical properties of the new quality belief curve distribution. Quality score 144B indicates a likelihood of tip 141B being of interest to a member 131.

Different mechanisms can be used to calculate a quality score from a quality belief curve distribution. In some embodiments, the mode of a quality belief curve distribution is used as a quality score. In other embodiments, the median of a quality belief curve distribution is used as a quality score. Quality scores can also be calculated using other types of statistical operations. For example, an “optimistic” point can be selected on the belief curve, such as selecting the point at which the true quality score is likely to be higher than this point, based on a specified likelihood.

202-204 can be repeated for tips 141A and 141C to generate quality scores 144A and 144C. Since no prior distribution data for tip 141C is in distributions 139, data from other similar tips, such as, for example, tip 151A, can be used to calculate initial distribution data for quality belief curve distribution for tip 141C. A similar tip can be a tip from the same author, related to the same topic, etc.

Quality scores for the various tips can be maintained in scores 138.

Method 200 includes for each of a subset of items included in the plurality of items, biasing the chance of selecting the item upward as a function of the corresponding quality score for the item so as to increase the likelihood of selecting the item during a random selection of items (205). For example, bias module 157 can bias the chance of selecting of one or more of tips 141A, 141B, and 141C upward as a function one or more of quality scores 144A, 144B, and 144C respectively. Thus, the chance of selecting tips having higher quality scores can be increased relative to tips having lower quality scores.

In some embodiments, the likelihood of selecting a tip is increased proportional to the tip's quality score. For example, a first tip may have a quality score (e.g., 80) that is twice as much as a quality score (e.g., 40) for second tip. As such, the first tip can be biased such that the first tip is twice as likely to be selected for presentation to a user relative to the second tip.

Other functions for biasing tips based quality score can also be used. A biasing function can include one or more of additive, multiplicative, and exponential mathematic operations.

Alternately or in combination, the likelihood of selecting a tip can be biased based on other considerations. For example, a tip can be biased to decrease or increase the likelihood of selection based on the recency of the tip, tip author, tip topic(s), etc. Other biasing can occur prior to or after biasing based on quality score. When other biasing occurs prior to quality score biasing, the other biasing can be implemented by altering quality scores. For example, score calculator 153 may generate a relatively low quality score for a tip. However, the tip may have a relatively high chance of resulting in a financial transaction when presented to users. As such, the tip can be biased to increase the likelihood of selection by increasing the quality score for the tip.

Biasing rules for biasing tips can be coded into bias module 157 and/or can be contained in biasing rules 158. Biasing rules can contain rules for biasing tips as a function of quality scores and/or biasing tips based on other considerations.

Alternately or in combination, one or more tips can also be filtered out prior to (or subsequent to) biasing. For example, filter module 154 can filter tip 141B from scores 138. Tips can be filtered for any number of reasons, including but not limited to: having a quality score that does not satisfy a quality threshold, containing particular metadata (e.g., topic, author, etc.), behavioral criteria, alternately derived quality scores, etc. Filter criteria for filtering tips can be coded into filter module 154 and/or can be contained in filter criteria 156. Filter criteria can contain criteria for filtering tips based on any of the number of reasons.

Method 200 includes subsequent to biasing, randomly selecting one or more items from among the plurality of items for presentation to the user (206). For example, tips 141A and 141C can be randomly selected for presentation to a user. Tips 141A and 141C can be randomly selected subsequent to biasing by bias model 157. Tips 141A and 141C can be maintained in output items 159. In some embodiments, a specified number of tips, such as, for example, 5, 10, 20, etc., are selected for presentation to a user.

Method 200 can be implemented from time to time, such as, for example, at specified intervals or in response to a user request for tips, to provide a set of tips for presentation to a user. In some embodiments, scores 138 are generated at different times and/or in response to different events than output items 159. For example, scores 138 can be generated at a specified interval, such as, for example, every 30 minutes. On the other hand, output items 159 are generated in response to a user request for tips.

Additionally, the functionality of matching engine 101 can be distributed across multiple different computer systems. In some embodiments, 201-205 are performed at a server, such as, for example, a server under the control of a trusted social network, to generate a larger set of tips (e.g., 100s or 1,000s of tips). The larger set of tips is transferred to a client computing device 133. Larger sets of tips can be transferred to a computing device 133 at a second specified interval (e.g., every six hours, every day, etc.). The computing device 133 can then select a smaller set of tips for presentation to a user in response to a user request.

Users can also configure settings at a computer device 133 so that lower quality tips are filtered from presentation. The quality can varied depending on if a tip is from a friend or is a public tip. A user may be willing to view lower quality tips from friends. On the other hand, the user may not be willing to view lower quality public tips. Lower quality tips can be flagged (and indicated in user behaviors 106).

Accordingly, matching tips to a user can produce a ranked set of results that has the advantage of leveraging Bayesian inference while also producing a diverse set of results over multiple viewings. Each of scoring, filtering, and biasing can be done at the aggregate, group, or individual level. In this way, personalization can be achieved. For example, tips whose topics a user is known to have interest in can be boosted. Personalization can also impact a prior belief curve determined in 201 or the data that is considered in 202. As another example, collaborative filtering techniques could be employed as a filter or in setting the priors for a given user or group. Those skilled in the art will recognize that numerous variations exist on each of the steps outlined that would remain consistent with the invention. One advantage of the matching strategy is that it is easily extensible and flexible.

For example, in some embodiments, one or more of score calculation, filtering, and biasing can be adjusted so that new and/or more popular tips have increased likelihood of being presented to a user. Users of social networking system 119 may configure a client application so that a single list of tips is presented as a news feed. Presenting new and/or more popular tips (relative to older and/or less popular tips) in a single list news feed can increase the user's level engagement with social networking system 119. This is beneficial both to the user and to social networking system 119. Users are presented with tips that may be of more interest. More engagement can also lead to more revenues for social networking system 119.

Matching engine 101 can also choose to highly weight a user's most recent actions, such as the tip they are currently engaged with, when determining which tips to display to user. In this way, the system can display related tips that are both related to the current tip being engaged with as well as likely to be of interest to the user. The methods described above can be combined with other algorithms for determining related tips including meta-data or text-based algorithms that compute similarity scores between tips.

Deep Links

Deep links can be used to redirect users to appropriate destination content (e.g., landing pages) in response to selecting a link based on computing device configuration, such as, for example, hardware (personal computer, mobile phone, etc.) and/or software (e.g., web browser, mobile web browser, operating system, application, etc.) configuration at a computing device. Deep links can detect wither a native application is installed and determine whether to redirect user to a page in the native application or the appropriate app store for downloading the application. Logic for deeplinking can be embedded in a web page eliminating the need to generate a deeplink for each page.

Deeplinks can be shared to virtually anywhere a URL is accepted regardless of the browser or Operating System used. Some examples may be web-based ads (banner ads, Facebook ads), social networks (Twitter, Pinterest), and even other native apps (Facebook for Android, Instagram for iOS). Each click on a deeplink can be logged for analytics. Loggable information may be source (which page the users were visiting from), destination (where the users where linked to), client device (information regarding the devices that the users were using), and geographical data (IP or GPS coordinates).

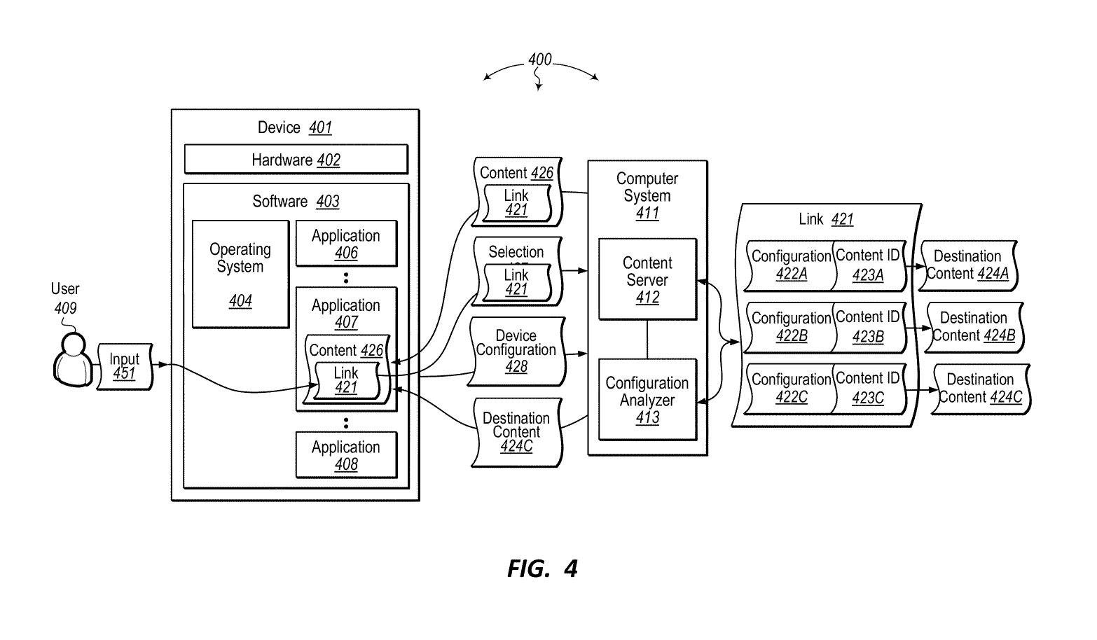

FIG. 4 illustrates an example computer architecture 400 that facilitates using deep links to select destination content. As depicted, compute architecture 400 includes device 401 (e.g., a client system) and computer system 411 (e.g., a server system). Computer system 411 includes content server 412 and configuration analyzer 414. Content server 411 is configured to serve content to other devices.

For example, computer system 411 can serve content 426 to device 401. Content 426 includes link 421, which can be selected to request additional content from computer system 411.

Device 401 includes hardware 402 and software 403. Software 403 further includes operating system 404 and applications 406, 407, and 408. Device 401 can receive content 426 from computer system 411. Device 401 can display content 426 within a user interface of application 407. Application 407 can be a web browser or mobile device application. Subsequently, user 409 can enter input 451 at device 401 to select link 421. In response, to user input 451, device 401 can send selection 427, containing link 421, to computer system 411.

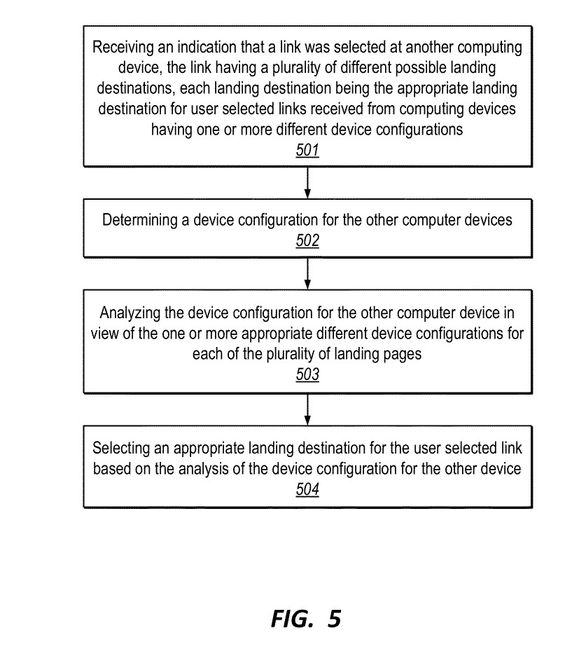

FIG. 5 illustrates a flow chart of an example method 500 for using a deep link to selected destination content. Method 500 will be described with respect to the components and data depicted computer architecture 400.

Method 500 includes receiving an indication that a link was selected at another computing device, the link having a plurality of different possible landing destinations, each landing destination being the appropriate landing destination for user selected links received from computing devices having one or more different device configurations (501). For example, computer system 411 can receive selection 427, containing link 421, from device 401. As depicted, link 421 has configurations 422A, 422B, and 422C corresponding to content IDs 423A, 423B, and 423C that corresponding respectively. Content IDs 423A, 423B, and 423C identity destination content 424A, 423B, and 424C respectively.

Thus, link 421 defines that a device of configuration 422A is to receive destination content 424A when the device selects link 421. Further, link 421 defines that a device of configuration 422B is to receive destination content 424B when the device selects link 421. Additionally, link 421 defines that a device of configuration 422C is to receive destination content 424C when the device selects link 421. Each of destination content 424A, 424B, and 424C can be essentially the same content but tailored for specified presentation configuration, such as, for example, in a web browser, in a mobile web browser, in a native application, etc. In some embodiments, a version of destination content can be an installation page for an application.

Method 500 includes determining a device configuration for the other computer device (502). Device 401 can send device configuration 428 to computer system 411. Configuration analyzer 413 can determine the configuration of device 401 from device configuration 428. From device configuration 428, configuration analyzer 413 can determine that device 401 includes hardware 402 (e.g., processor type, amount of system memory, etc.), is running operating system 404 (e.g., Android, iOS, etc.), and is presenting content in application 407 (e.g., a web browser, native application, etc.). Determining a device configuration can also include determinign a device type such as, for example, personal computer or mobile phoine.

Method 500 includes analyzing the device configuration for the other computer device in view of the one or more appropriate different device configurations for each of the plurality of landing pages (503). For example, configuration analyzer 413 can analyze the configuration of device 401 in view of configurations 422A, 422B, and 422C. Configuration analyzer 413 can determine that the configuration of device 401 is a match for or at least substantially similar to one of configurations 422A, 422B, and 422C. For example, Configuration analyzer 413 can determine that the configuration of device 401 is a match to configuration 422C.

Method 500 includes selecting an appropriate landing destination for the user selected link based on the analysis of the device configuration for the other device (504). For example, configuration analyzer 413 can select destination content 424C as an appropriate landing destination in response to selection of link 421. Content server 412 can send destination content to device 101. Device 401 can present destination content 424C in a user interface of application 407.

Caching System

Due to resource constraints at mobile computing devices as well as the possibility of intermittent connectivity from a mobile computing to the trusted social network, the trusted social network can use a four-tier caching system to help insure content availability.

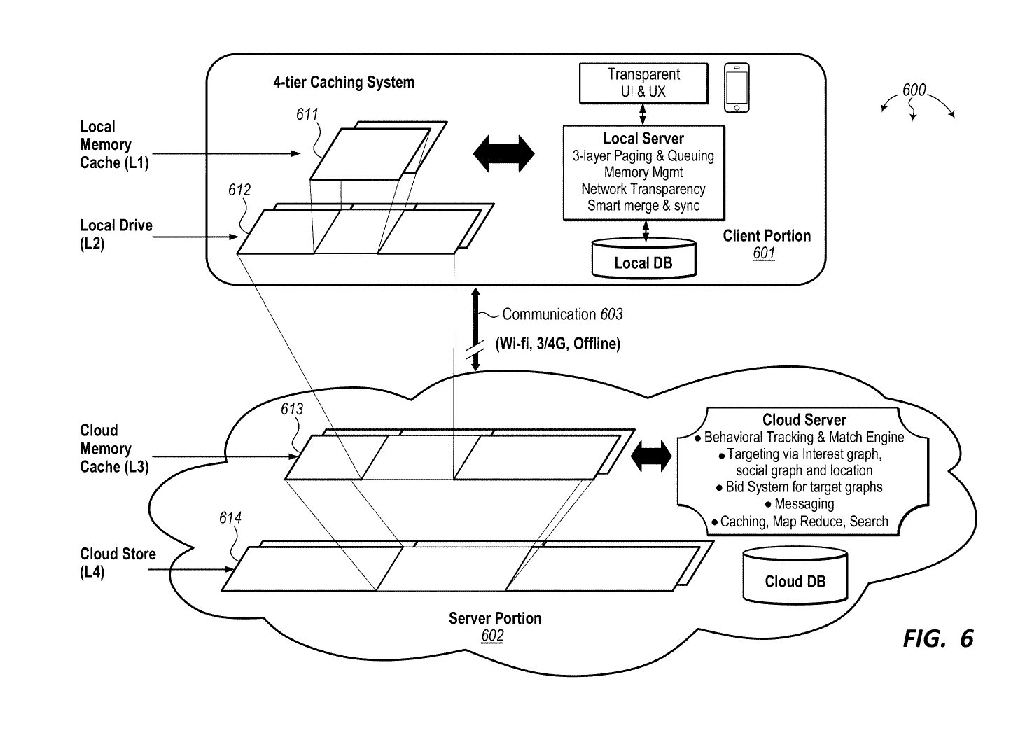

FIG. 6 illustrates an example computer architecture 600 that facilitates a four-tier caching system. A user application for a trusted social network can use a client-server model. Client portion 601 of the use application can run on a mobile computing device of some kind (e.g., a smart phone), and can be used to navigate, view, and create or modify content. It may be that there is far more content than would fit into the memory of a mobile computing device. As such, the actual content is stored permanently in the server portion 602 of the user application, which runs in a much larger, centralized computing facility separate from the client. The client and server communicate 603 with each other using some sort of network, such as local WiFi or the 3G/4G offering of a telecom provider.

When a client displays content, it retrieves the content from its first-level (“L1”) cache 611, which resides in the smartphone's faster local memory. If the needed content is not present in the L1 cache, the L1 cache code itself looks to the second-level (“L2”) cache 612 on the smartphone's larger, but slower, persistent local drive. If the content is in fact present in the L2 cache, then the L1 cache copies the data from the L2 cache to itself, then answer the original application request with that data. Because the data has been copied to the L1 cache, a subsequent request for that same data can be answered more quickly directly out of the L1 cache.

If the data is not present in the L2 cache, then a similar pattern is followed for obtaining data from a third-level (“L3”) cache 613. The L3 cache resides apart from the smartphone in “the cloud”, for example, at a Content Distribution Network (CDN), a separate caching server residing in trusted social network's computing facility, or it could be a simple memory cache in the server portion of the server-side Tips application. Although the L3 cache is separated from the smartphone by a potentially slow and unreliable network, it is likely more quickly accessible than the canonical server data. If the L3 cache does not contain the data either, then the data is ultimately be retrieved from the canonical data store (“L4”) 614 in the server portion of the application, using a similar pattern as before for updating the higher-level caches.

The caching system allows a user to create new content or modify existing content at a time and place that makes sense in the context of that content. For example, if a user is creating content about perfecting one's golf swing, it would make sense to allow the user to work on this content while standing on a golf course. However, if the golf course happened to be out of network range, the client application can use a combination of caching and queuing to hide the effects of a poor or missing client-server connection.

Further, since the L2 cache stores content in the smartphone's persistent storage, that data is available even when the phone has no network connection. The L2 cache keeps enough metadata about the content that it contains so that users can filter or sort that data normally. Thus, when the phone's network connection is poor or missing, the application can continue to display content in a meaningful way. The user's experience is largely unchanged.

When new content is created or existing content is modified, the new data is copied directly to the smartphone's L1 and L2 caches, which makes it available for viewing immediately. In addition, the new or modified content is stored on a separate queue in the smartphone's persistent local drive for transmission to the server. This way, if the network connection is missing or unreliable, the data can be stored locally until the network connection becomes available again, even if the application is stopped. However, because the data was also copied to the L1 and L2 caches, users see the effects of their changes even if those changes have not yet been recorded in the L3 or L4 layers.

Additionally, new and modified content in the L1 and L2 caches interacts consistently with cached content obtained from the L3 cache. Thus, if some user A had obtained (for example) 10 pieces of content while the network was available, then lost network connectivity and modified one of those items, user A would observe the updated content item intermingled with the 9 unmodified items. Once the network was restored, the modified content would be uploaded to the L3 and L4 layers and other users would then see the modifications as well.

Similarly, if some other user B had modified another one of user A's content items while user A was offline, those modifications would become available to the user A once the network was restored. The modifications made by user B would be observed by user A without affecting the changes that user A had made to his/her own content.

If both user A and user B modify the same content item, the system has several options:
The first user to submit a modification “wins” and prevents the second user from making a change. The second user would then have to reload the content with the first user's changes and then re-modify and re-submit their own changes.
The second user to submit a modification “wins” and replaces the changes made by the first user
Both changes are merged if possible so neither set of modifications is lost

The choice of strategy is based on the complexity of the changes (e.g. if both users are modifying the same portion of the content), the amount of time since the user downloaded the original content, and the amount of time between the two modification attempts.

Monetization with Mobile Commerce

A tip infrastructure can be monetized in a variety of different ways. Tips can be used to sell products. Tips can be used as a way to promote products. Tips can be used to provide members with rewards.

In these embodiments, the tip infrastructure can essentially be used as a market place for tips. Vendors and users are provided with a mechanism where they can buy and sell products. Vendors can promote or sponsor tips that include product placements as opposed to or in addition to information. When a user selects the tip, the user can be taken to a direct buy page. Vendors can also use the tip infrastructure to provide coupons to users. For example, advertisements or other commerce related content can be included in an information tip stream. Selected commerce or ads in the middle of informational tip stream are more effective than traditional ecommerce or ads. For example, while a user is fascinated with a finger nail tip, she will be far more willing to buy a related nail polish product at the same time.

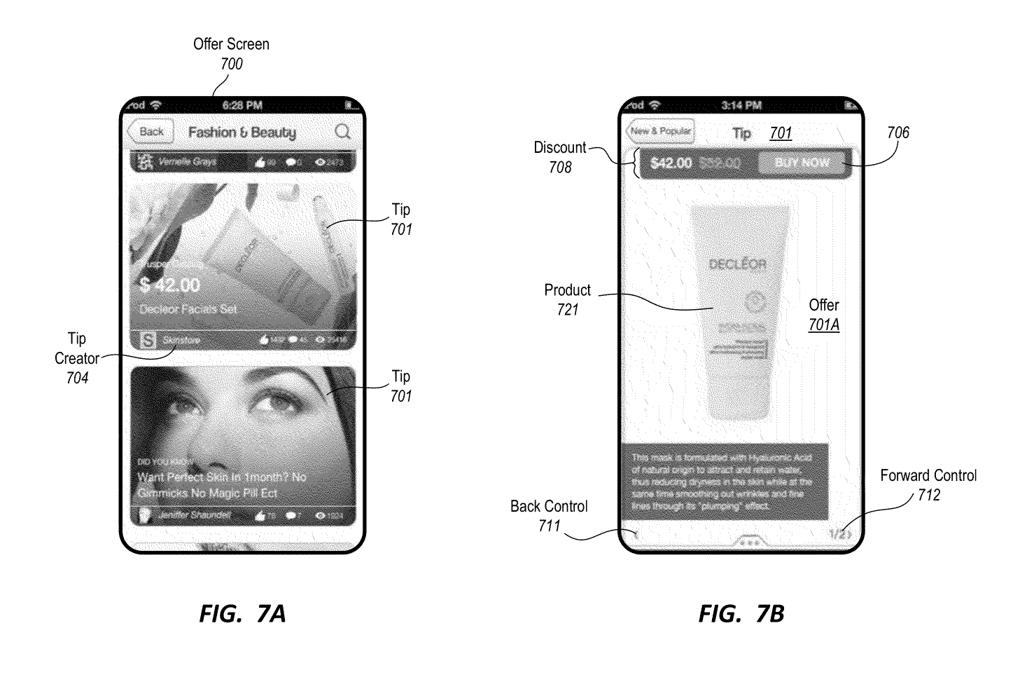

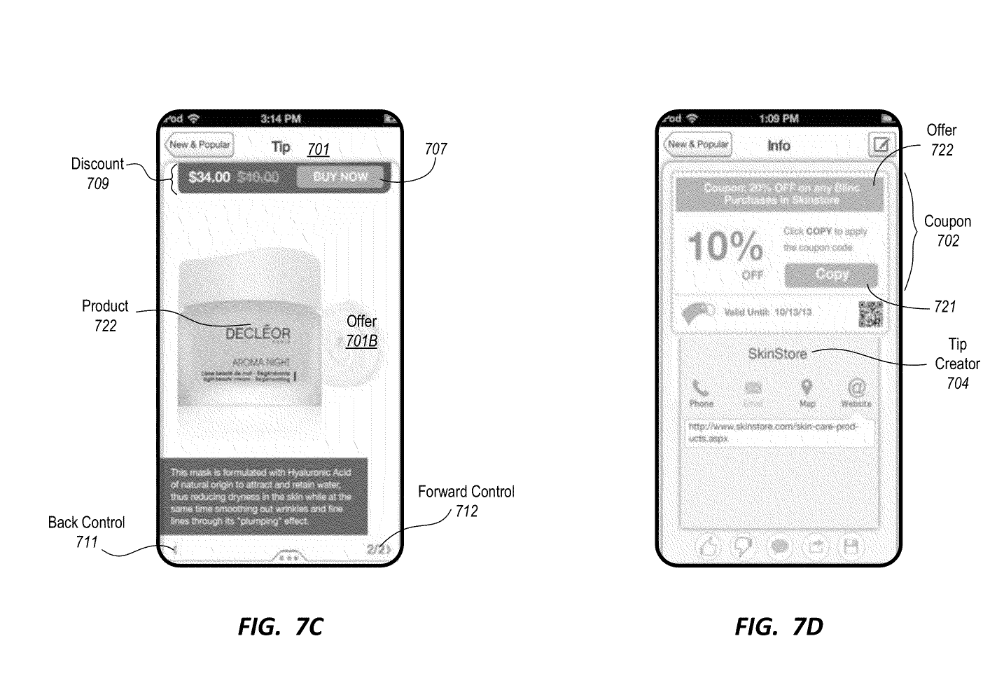

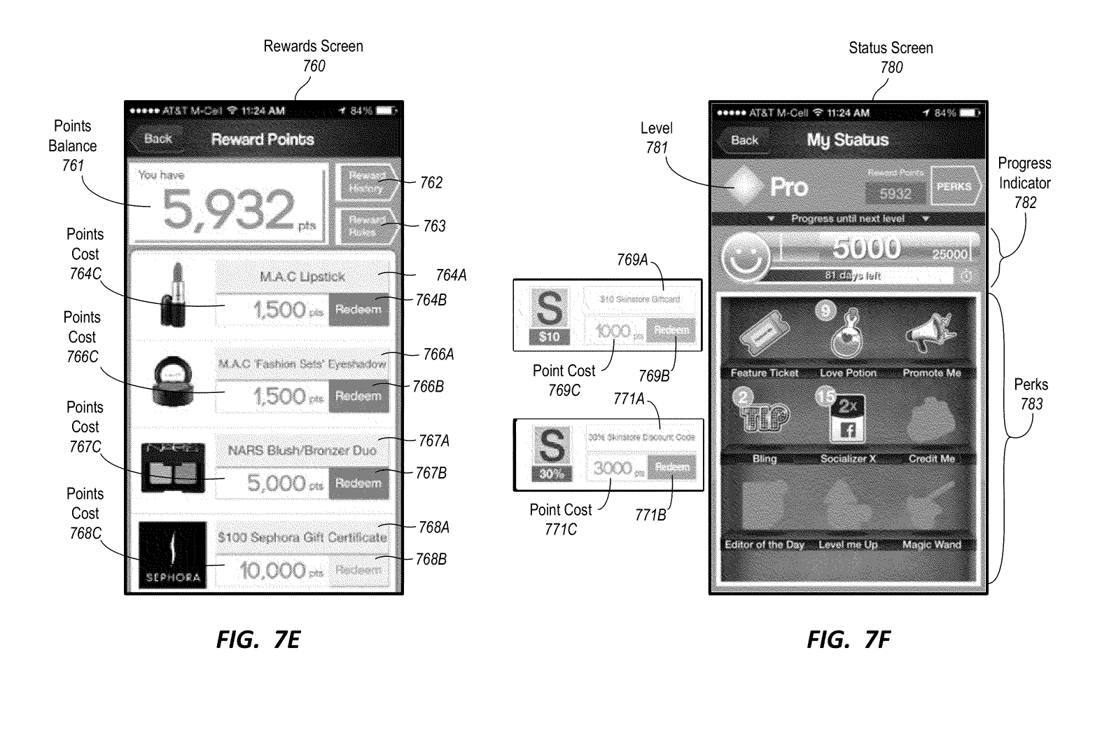

FIGS. 7A-7D depicts an example of offer products for sale through a tip. Depicted in FIG. 7A, offer screen 700 presents tip 701 and tip 702 to a user. A user can select tip 701 to access one or more offers from tip creator 704.

For example, upon selecting tip 701, a user's display device can transition to offer 701A in FIG. 7B. Offer 701A is on offer to the user to purchase product 721. Offer 701A indicates discount 708 and includes buy now button 706. Discount 708 represents how much the user can be save by buying product 721 though offer 701A. Buy now button 706 can transition the user to page for purchasing product 721 (e.g., a web page for tip creator 704 or some other e-commerce site). Back control 711 can be selected to transition back to offer screen 700. Forward control 712 indicates that offer 701A is the first of two offers from tip creator 704. Forward control 712 can be selected to transition to the next offer.

For example, upon selecting forward control 712, a user's display device can transition to offer 701B in FIG. 7C. Offer 701B is on offer to the user to purchase product 722. Offer 701B indicates discount 709 and includes buy now button 707. Discount 709 represents how much the user can be save by buying product 722 though offer 701B. Buy now button 707 can transition the user to page for purchasing product 722 (e.g., a web page for tip creator 704 or some other e-commerce site). Back control 711 can be selected to transition back to offer 701A. Forward control 712 indicates that offer 701B is the second of two offers from tip creator 704. Forward control 712 can be selected to transition to further information associated with tip creator 704.

For example, upon selecting forward control 712, a user's display device can transition to coupon 702. Coupon 702 can be a coupon for receiving a general discount (10%) on products purchased from tip creator 704. Copy control 721 can be selected to apply a corresponding coupon code to a purchase. Coupon 702 also includes offer 722, offering a different discount (20%) on a smaller set of products (e.g., products from the same manufacturer). Offer 722 can be selected to transition a user's display device to a coupon associated with offer 722.

Accordingly, embodiments of the invention include methods for transitioning between different offer screens associated with a selected tip. Users can transition forward and backward between offers to find an offer of interest. If a user decides not to select an offer, the user can transition to a coupon screen for obtaining a coupon that provides a general discount. The coupon screen can also include narrower (e.g., brand specific) coupons that be selected to transition to further offers.

A rewards interface can be used to do brand promotions. Users may check their reward points balances many times and relatively frequently prior to actually redeeming points. As such, advertisements can be placed on the rewards interface so that users view then the advertisements.

Within a tip infrastructure users can have various different levels of status based on their level of interaction with the tip infrastructure. A user's status level can be upgraded as they publish more tips and as other users interact with their published tips. Based on a status level, a user can be given various virtual goods (perks) and/or additional points to promote their (or others) tips for specified periods of time (e.g., 3 days).

FIGS. 7E and 7F depict an example of virtual goods. FIG. 7E depicts rewards screen 760. Screen 760 shows a points balance 711 for a user. Reward history 762 and reward rules 763 can be selected to see previously obtained reward and rules for a rewards program respectively. Different offers 764A, 766A, 767A, and 768A for products are depicted. Each offer indicates a points cost 764C, 766C, 767C, and 7868C respectively. Each offer also has a redeem button 764B, 766B, 767B, and 7868B respectively. Selecting a redeem button for an offer reduces the user's points balance by the corresponding point cost and also causes the product to be sent to the user. For example, selecting redeem button 764B deducts 1,500 points from points balance 761 and also causes “M.A.C. Lipstick” to be delivered to the user.

Other offers, such as, for example, discounts and gift cards can also be included in a rewards screen. For example, offer 769A is for a gift card and offer 771A is for a 30% discount. When redeem button 769B is selected, 1000 points (point cost 769C) can be deducted form points balance 761 and a “$10 Skinstore Giftcard” can be delivered to the user. Similarly, when redeem button 771B is selected, 3000 points (point cost 771C) can be deducted form points balance 761 and a “30% Skinstore Discount Card” can be delivered to the user. Products can be delivted physically or electronically as appropriate.

In some embodiments, users are distributed points for performing “good deeds” within social networking system 119. Good deeds can include liking or sharing tips, providing help to another user, inviting users to join social networking system 119, etc.

Points can be awarded from an unlimited point of points or a fixed pool of points. In some embodiments, a fixed pool of points is essentially configured as prize money. Users can compete with one another to be awarded points from the fixed pool of points. Since users are in competition, the chance of users gaming the system (e.g., liking each other's tips just to gain points) is reduced. Different fixed pools can be allocated at specified intervals (e.g., each day) and/or on a per topic basis (e.g., sports, fashion, gardening, etc.). At the end of the specified interval or some other configured interval, points from the allocated pools can be awarded to users based on the popularity (ranking) of their tips. User tips can be ranked based on user behavior, such as, for example, likes, shares, etc.

Points can be awarded using various different criteria. In some embodiments, points are awarded to users when their tips satisfied a popularity threshold. A threshold can include having a tip in a top N (e.g., 20, 50, 100, etc.) popular tips for a specified category. A threshold can include having a tip that is in a top N % (e.g., 10%, 20%, etc.) of popularity for a specified category. Different combinations of thresholds can also be used.

In some embodiments, both a number threshold and one or more percentage thresholds can be used to award points. For example, for a specified topic, the N most popular tips can be awarded some points, tips in the top X % (e.g., 20%) of tips can be award some points, and tips in the top Y % (e.g., 10%) of tips can be awarded some tips. More points can be awarded to higher ranked tips that satisfy a threshold. For example, the creator of a 1^{st} ranked tip can be awarded more points than the creator of a 2^{nd} ranked tip, the creator of the 2^{nd} ranked tip can awarded more points than the creator of a 3^{rd} ranked tip, etc. Using both a number threshold and one or more percentage thresholds help account for variance in the volume of tips.

The amount of points allocated to a specific topic can be varied to attempt to increase or decrease engagement with the specified topic. For example, more points can be allocated to a topic to attempt to get more users to engage with the topic.

FIG. 7F depicts a status screen for a user. Level 781 indicates the status level of the user. Progress indicator 782 indicates progress until the next higher status level is achieved. Perks 783 represent various perks available to the user to promote tips and gain more points. Different perks can promote tips in different ways. Some perks can be used to bias how matching engine 101 handles a tip. Other perks can add effects, such as, for example, sound effects to a tip when the tip is presented. Other perks can be applied to gain extra points, such as, for example, when sharing a tip on another social network.

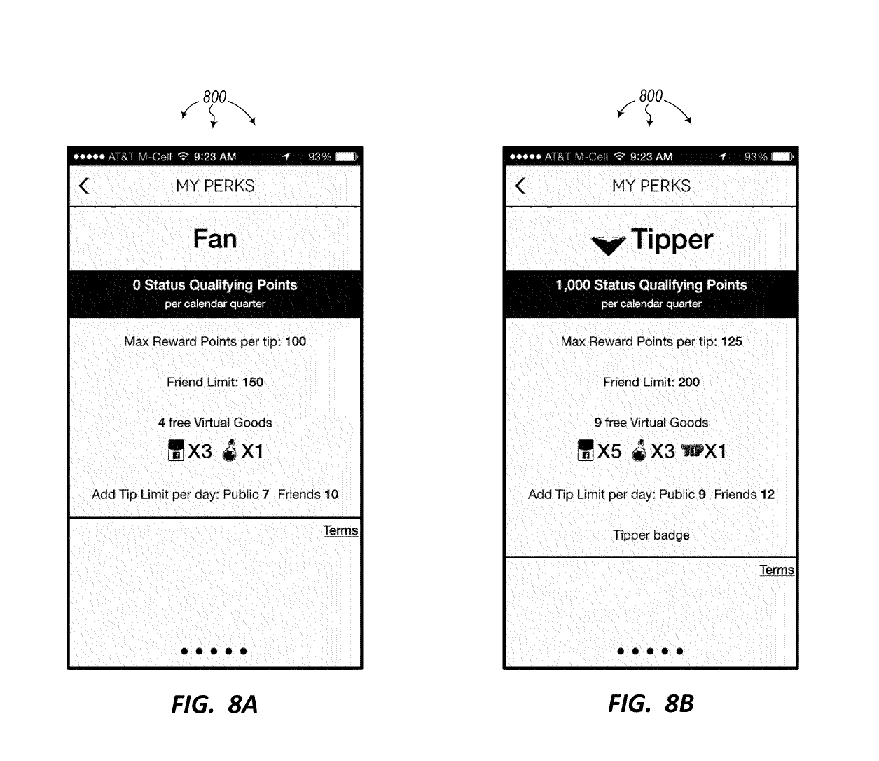

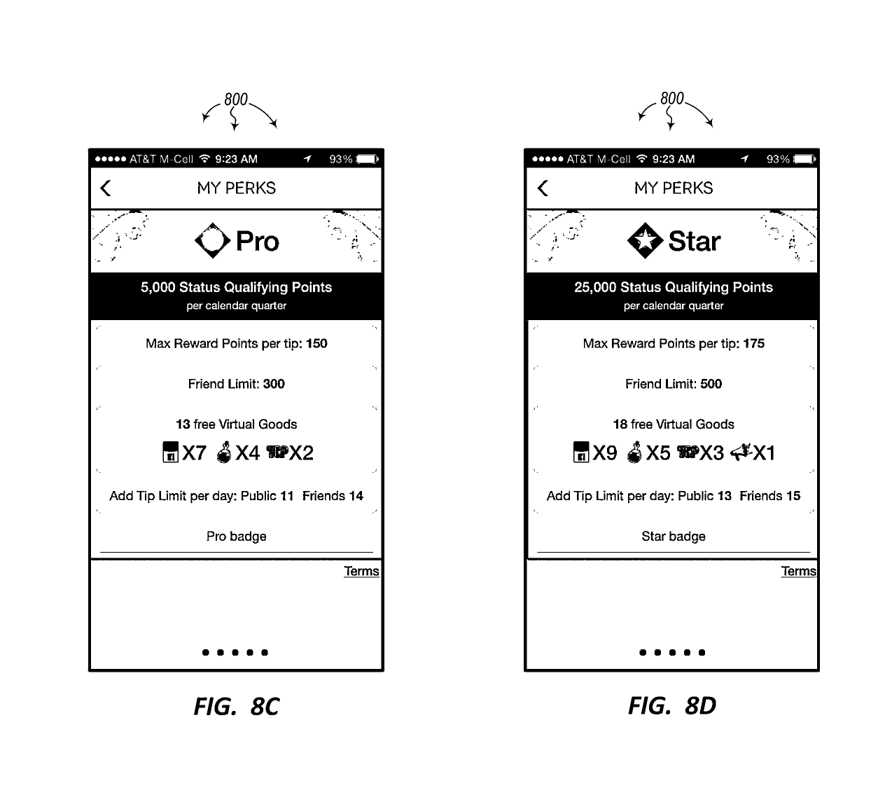

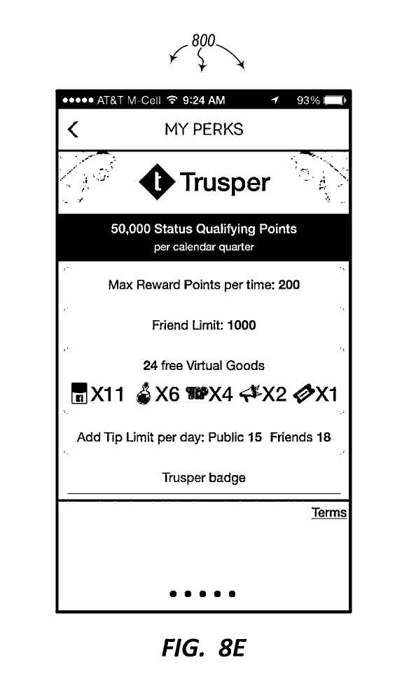

FIGS. 8A-8E depict different status levels and corresponding promotional tools that can be used to promote tips. Points can be also be purchased or obtained through sharing tips on other social networks. Matching engine 101 can bias a promoted tip so the promoted tip ranks higher and is presented to more users.

Accordingly, embodiments of the invention include methods for creating and promoting tips. Tip creators can create tips to market and sell their products. Tip creators can then apply one or more of perks 703 to a tip to promote their tip to other users. For example, a tip owner can apply a perk to bias their tip. Biasing a tip can increase the likelihood of matching engine 101 selecting the tip for presentation to a user (e.g., biasing module 157 can consider user applied perks when biasing tips).

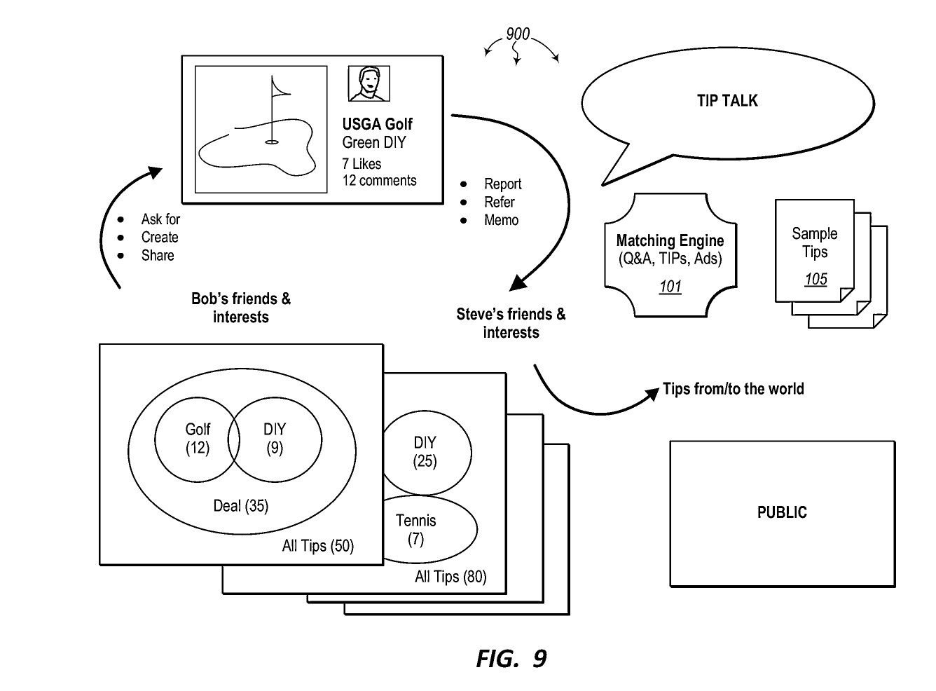

FIG. 9 depicts a data flow 900 for a market place of tips.

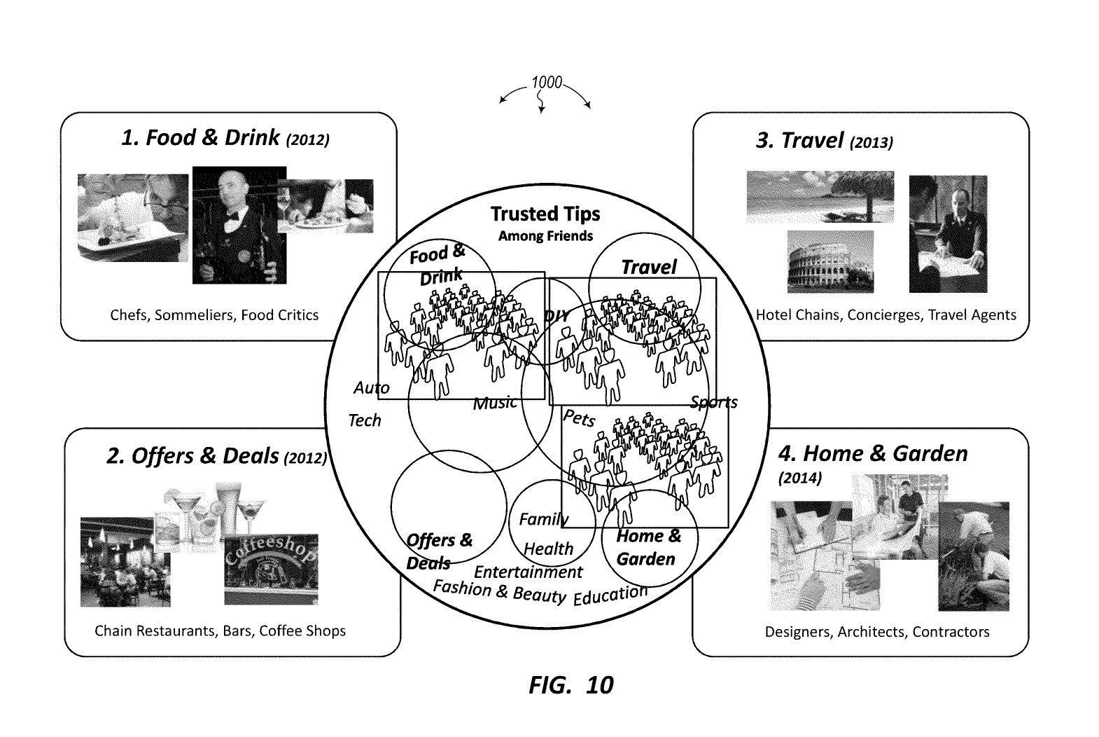

FIG. 10 depicts a data flow 1000 for a market place of tips. Within data flow 800 overlapping circles indicate common interests among different users of a trusted social network infrastructure.

Help Out

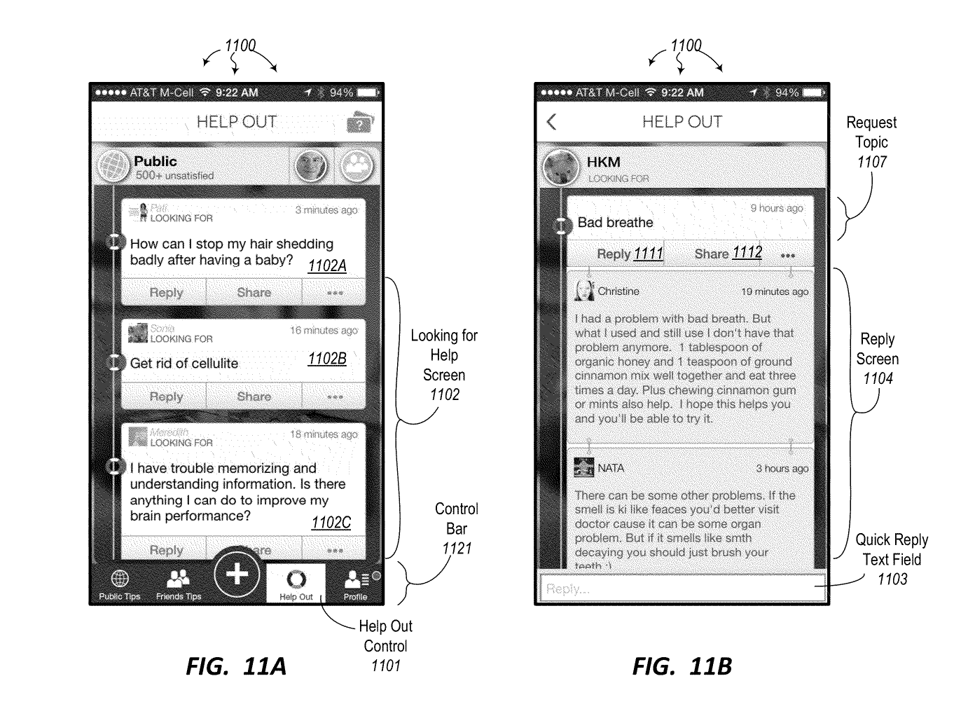

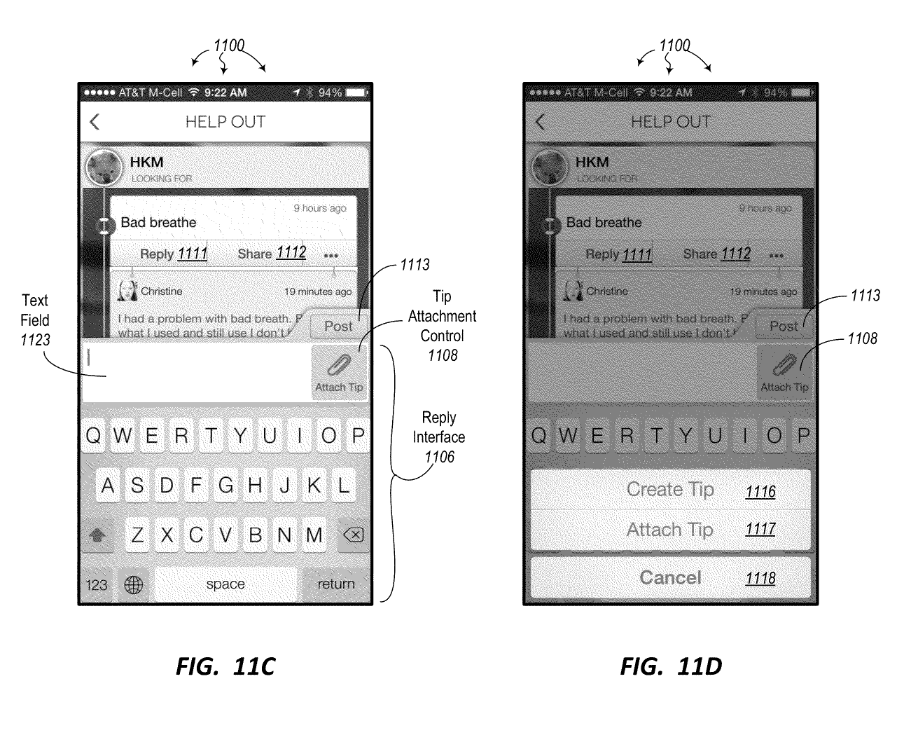

Within a tip infrastructure, users can also requests tips from other users. A responding user, can answer with an existing tip, create a new tip, or in a text box. FIGS. 11A-1DD depict a user interface 1100 for helping out with a tip. As depicted, in FIG. 11A, user interface 1100 includes help out control 1101 looking for help screen 1102, and control bar 1121. Looking for help screen 1102 includes requests for help 1102A, 1102B, 1102C, etc. Each request for help 1102A, 1102B, 1102C, etc., represents a request from a user for help with a particular topic, situation, etc. A user can select help out control 1101 from control bar 1121 to transition their display device to looking for help screen 1102.

A user can select a request for help from the screen to transition to further information, including replies form other users, about the request for help. For example, in FIG. 11B, a user has selected a request for help related to request topic 107 “bad breathe.” Reply screen 1104 depicts other replies to the request for help for topic 107 “bad breathe.” Text can be entered into quick reply text field 1104 to submit a text only reply for topic 107 “bad breathe.” Alternately, a user can select reply control 1111 to submit a reply for topic 107 “bad breathe” that includes text and/or a tip. A user can also select share 1112 to share the request for help with other users, possible on other social network sites.

Upon selecting reply 1111, a user can be transitioned to a reply interface for reply to the request for help. For example, as depicted in FIG. 11C, reply interface 1106 is presented to a user. Reply interface 1106 allows a user to enter text in text field 1123 and/or attached a tip by selecting tip attachment control 1108. Upon selecting tip attachment control 1108, a user can be transitioned to a tip attachment interface.

For example, as depicted in FIG. 11D, tip attachment interface 1124 is presented to a user. Tip attachment interface 1124 includes create tip control 1116, attach tip control 1117, and cancel 1118. A user can select create tip control 1116 to create a new tip for attachment to a reply for the request for help. A user can select attach tip control 1117 to attach an existing tip to a reply for the request for help. A user can select cancel 1118 top return to replay interface 1106 without attaching a tip. Referring back to FIGS. 11B and 11C, when a user has completed entering their reply (including text and/or a tip) through reply interface 1106, the user can select post control 1113 to post their reply to reply screen 1104.

In some embodiments, help out includes social interactive environment for users to ask help or questions to their Friends or Public for answers in a format of live chats as well as tips. When a user creates a help out request, he or she can send the request to individual Friends, her entire Friends circle in social networking system 119, or to the whole public. The help out question can be posted to the intended targets in real-time via several different communication methods, such as, for example, email, text, in-app notification, through other social networks, and others. Friends or the public can respond by posting answers or comments on the questions or answers as well as attach tips to the answers or comments. When the user who asked the question is satisfied with one or several answers to her question, he or she can switch the question to “answered”.

Users are able to switch screens to see all of the requests from friends, public or themselves. Users can also share a help out request to friends on social network 119, friends on other social networks, or anyone in their contact list they believe may be able to help out on the question.

As such, any of users 132 (through a corresponding device) can submit a tip request to social networking system 119 and receive back relevant tips. Users can include user tip criteria (e.g., topic, author, more recent tips, etc.) when requesting tips. Filter module 154 and/or bias module 157 can consider user tip criteria (e.g., included in user behaviors 106) when filtering out and/or biasing tips. Selected tips can then be returned to a user's device.

For Hire/Help Wanted

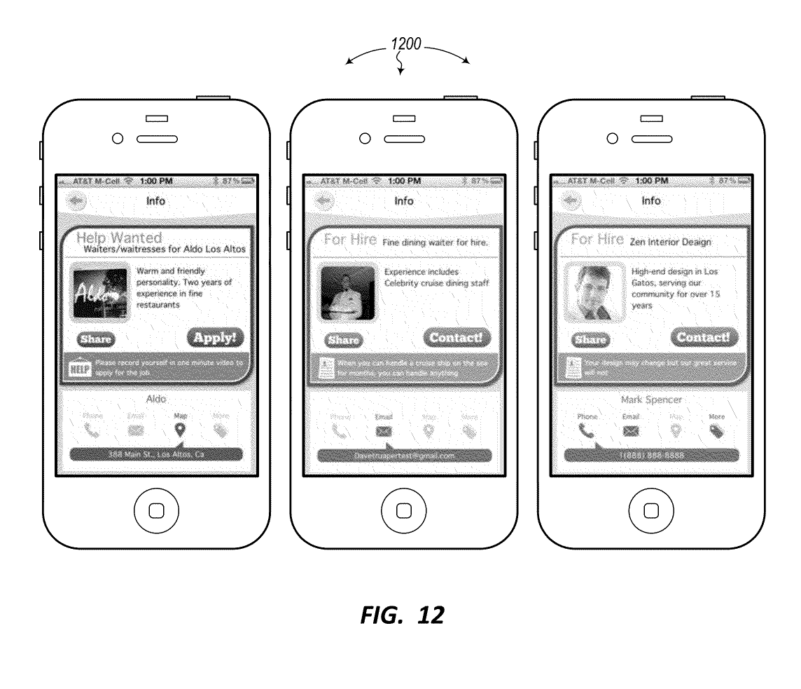

Prospective employers can create tips for job postings. Job seekers can create tips of themselves including relevant personal information as well as a visual resume (a video). Job seekers can use self-created tips to apply for posted jobs. FIG. 12 depicts user-interface screen shots 1200 of for hire and help wanted ads.

Find Nearby Friends and One-Click Adding

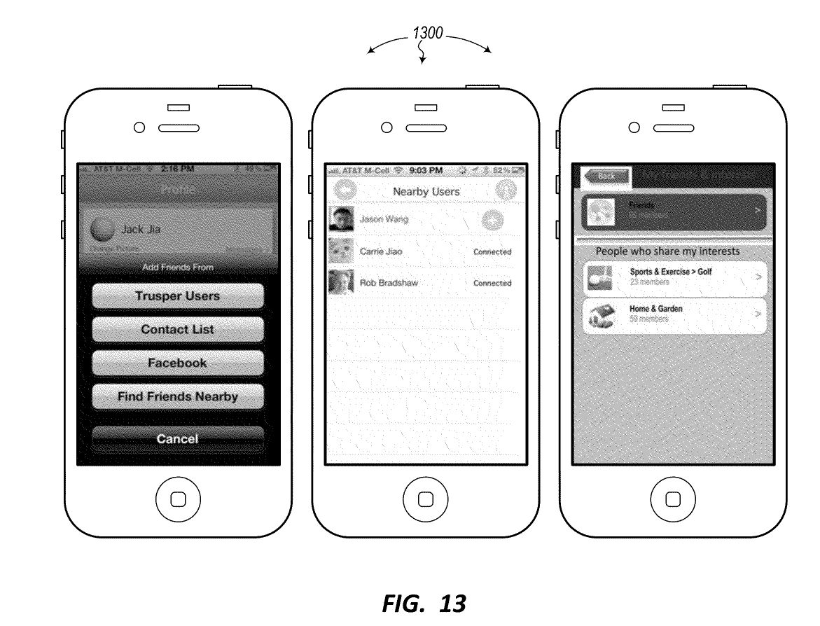

A trusted network infrastructure and/or client application can include geo-location functionality. Geo-location can be used to make users aware of other nearby users that are using the application. Geo-location can be used for the purpose of getting users that are mutually searching for nearby friends to connect with one another. This is especially useful and convenient for friends in a party where they are sharing Tips in person. One friend can invite several other friends in the party to connect in order to share their Tips online. Friends can be added in a single click. FIG. 13 depicts user-interface screen shots of one click adding of a friend based on geographic proximity.

Tip Creation

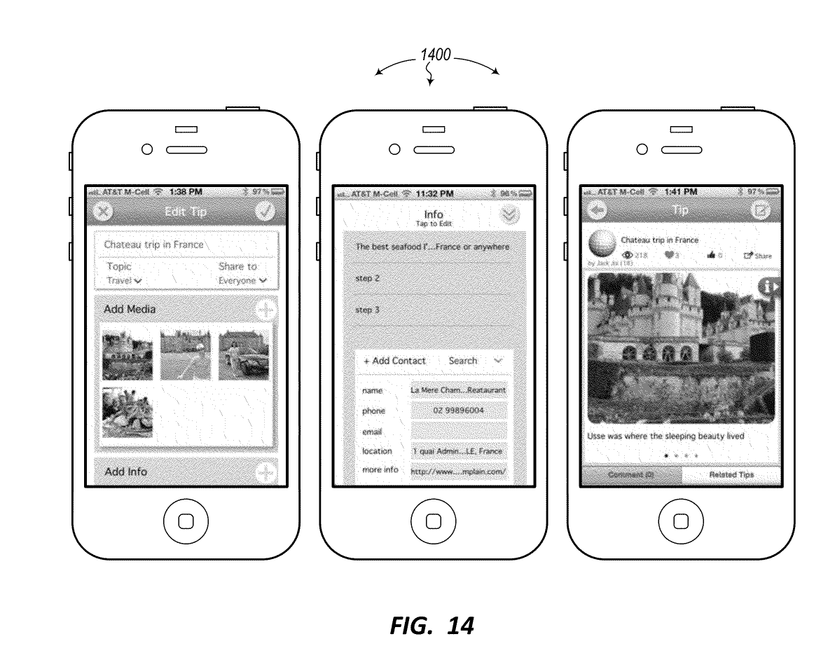

FIG. 14 depicts user-interface screen shots of tip creation. To add a tip the “+” icon is selected.

Tip View and Tip Talk

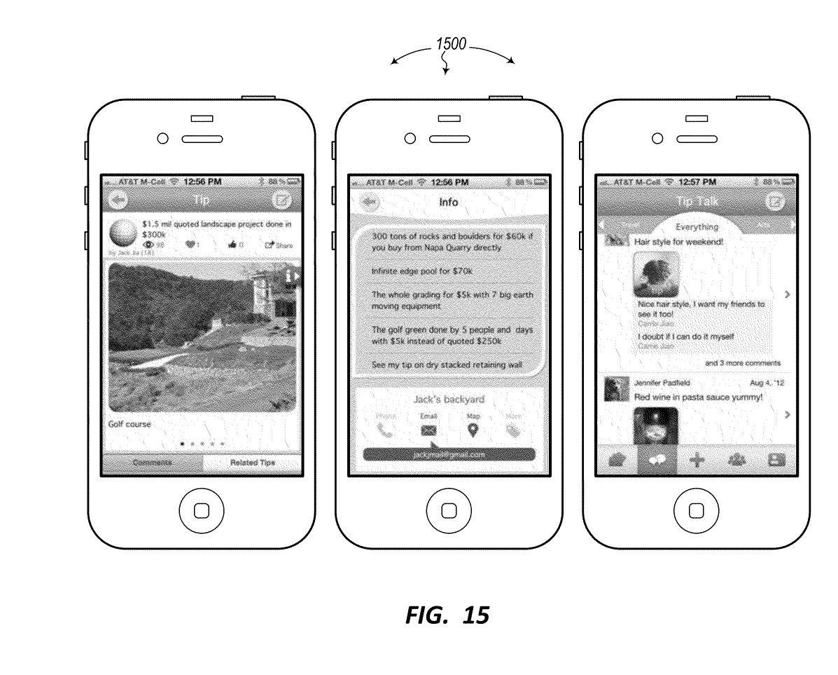

FIG. 15 depicts user-interface screen shots of viewing a tip, information and tip talk. As shown, for tip talk the “bubbles” icon is selected.

Deal, Coupon, and Following

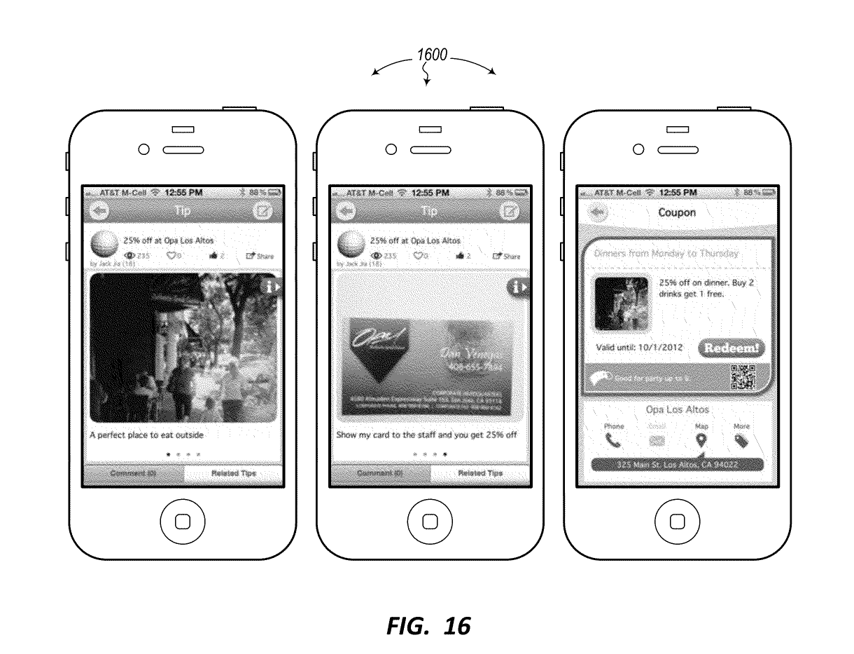

FIG. 16 depicts user-interface screen shots of deal, coupon, and following.

Punch Card and Other Integrations

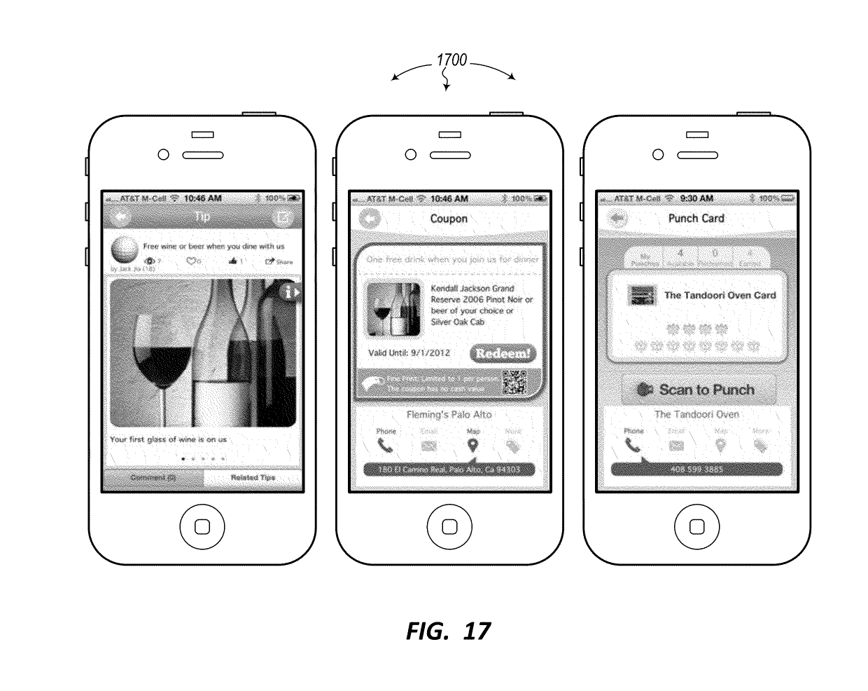

FIG. 17 depicts user-interface screen shots of a punch card and other integrations.

Related Tips

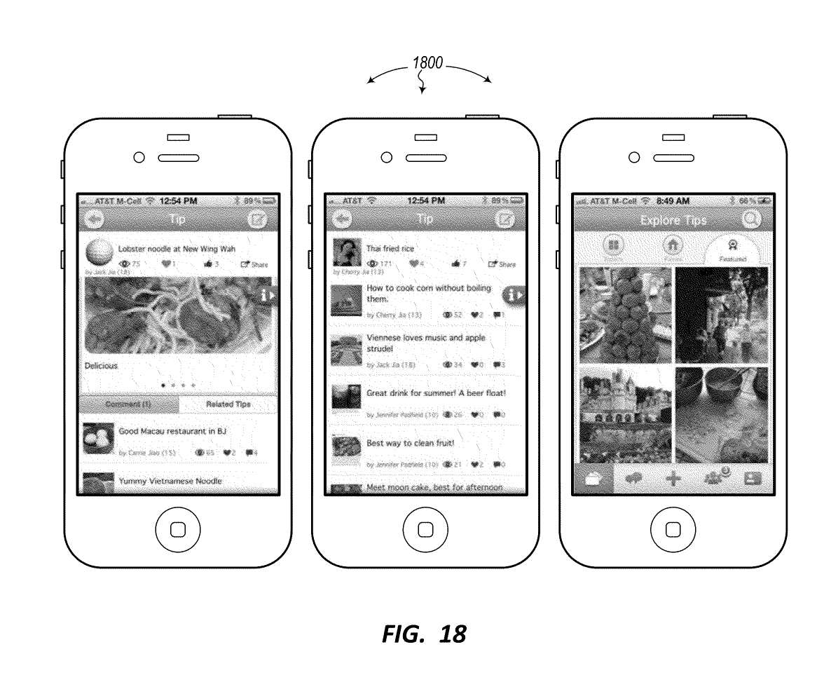

FIG. 18 depicts user-interface screen shots of related tips, sponsored ads, and features

Profile

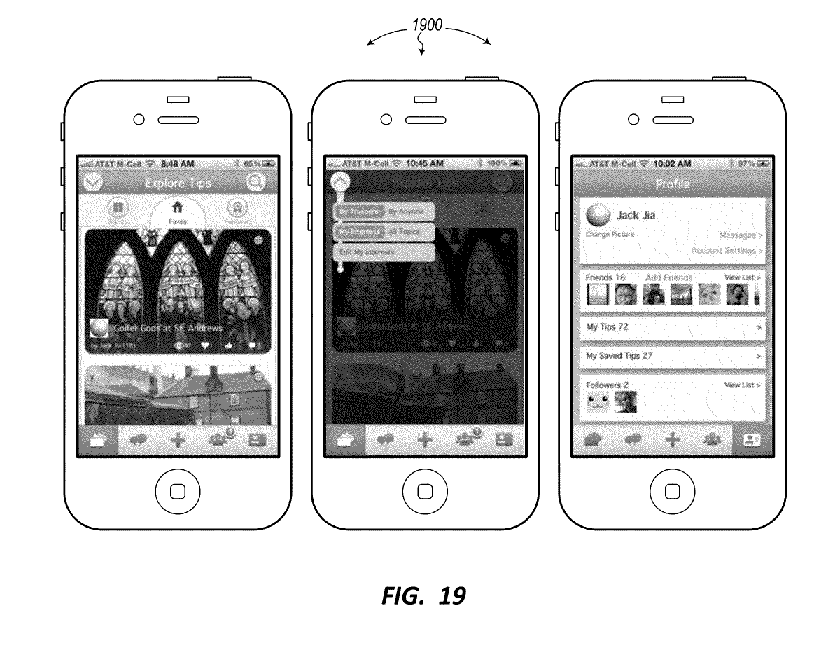

FIG. 19 depicts user-interface screen shots of favorites and profile information. As shown, the “index card” icon can be selected to access profile information.

The “people” icon can be selected to access community.

Category Specific Friends/Implicit Interest Groups

Users can have category specific friends. Engagement with a category specific friend can be limited to tips within a specific category. For example, if a user has a “golf friend” the user can be presented with friend's tips related to golf but not tips from other categories. In some embodiments, subsets of friends that have shown an interest in specific categories can be detected automatically.

Transitive Visibility Via Repost or Share

A tip posted by someone who is not a friend of a user can become visible to the user if it is reposted by someone who is a friend.

Transition (Upgrade) Message from Friends Visibility to Public Visibility

When a message is reposted with “friends” visibility a specified (N) number of times, the message can (automatically) be transitioned to have “public” visibility.

User-Interface

A variety of different user-interfaces (including those already described) can be used at a client application to give a member access to a trusted social network.

Client Application API

Various APIs can be used by a client application to facilitate access to a trusted social network, the APIs can include, but are not limited to the APIs in attached appendix A.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. At a computer system, the computer system including a processor and system memory, a method for selecting items for presentation to a user based on item quality, the method comprising:
accessing a plurality of items, each of the plurality of items potentially being of interest to the user;
accessing a plurality of quality scores, each quality score in the plurality of quality scores corresponding to an item in the plurality of items, each quality score indicative of a likelihood of a corresponding item being of interest to the user;
for each of a subset of items included in the plurality of items, biasing the chance of selecting the item upward as a function of the corresponding quality score for the item so as to increase the chance of selecting the item during a random selection of items; and
subsequent to biasing, randomly selecting one or more items from among the plurality of items for presentation to the user.

2. The method of claim 1, further comprising prior to accessing the plurality of quality scores:
for each item in the plurality of items:
determining a prior distribution for a quality belief curve for the item based on data from other similar items contained in the plurality of items; and
computing a new distribution for the quality belief curve for the item from user behavioral data associated with the item.

3. The method of claim 2, further comprising prior to accessing the plurality of quality scores:
for each item in the plurality of items:
calculating the quality score for the item based on statistical properties of the new distribution for the quality belief curve for the item.

4. The method of claim 3, wherein the plurality of items is a plurality of tips.

5. The method of claim 3, wherein calculating the quality score for the item based on statistical properties of the new distribution comprise selecting an optimistic point on the new distributions for the quality belief curve.

6. The method of claim 1, further comprising, prior to biasing, filtering out any items that do not meet a specific quality threshold.

7. The method of claim 1, further comprising, prior to biasing, filtering out at least one item based on associated metadata.

8. The method of claim 1, further comprising, prior to biasing, filtering out at least one item based on one or more of: behavioral criteria and alternately derived quality scores.

9. The method of claim 1, further comprising prior to randomly selecting one or more items, for each of a second subset of items included in the plurality of items, additionally biasing selection of the item based on one or more of: the recency of the item and metadata associated with the item.

10. A computer program product for use at a computer system, the computer program product for implement a method for selecting items for presentation to a user based on item quality, the computer program product comprising one or more computer storage media having stored thereon computer-executable instructions that, when executed at a processor, cause the computer system to perform the method including the following:
access a plurality of items, each of the plurality of items potentially being of interest to the user;
access a plurality of quality scores, each quality score in the plurality of quality scores corresponding to an item in the plurality of items, each quality score indicative of a likelihood of a corresponding item being of interest to the user;
for each item in the plurality of items:
determine a prior distribution for a quality belief curve for the item based on data from other similar items contained in the plurality of items; and
compute a new distribution for the quality belief curve for the item from user behavioral data associated with the item; and
calculate the quality score for the item based on statistical properties of the new distribution for the quality belief curve for the item;
for each of a subset of items included in the plurality of items, biasing the chance of selecting the item upward as a function of the corresponding quality score for the item so as to increase the chance of selecting the item during a random selection of items; and
subsequent to biasing, randomly selecting one or more items from among the plurality of items for presentation to the user.

11. The computer program product of claim 10, wherein the plurality of items is a plurality of tips.

12. The computer program product of claim 10, further comprising computer-executable instructions that, when executed, cause the computer system to prior to biasing, filter out any items that do not meet a specific quality threshold.

13. The computer program product of claim 10, further comprising computer-executable instructions that, when executed, cause the computer system to further bias at least one item based on the likelihood of the item triggering a financial transaction.

14. The computer program product of claim 10, further comprising computer-executable instructions that, when executed, cause the computer system to filter out at least one item based on one or more of: behavioral criteria and alternately derived quality scores.

15. The computer program product of claim 10, further comprising computer-executable instructions that, when executed, cause the computer system to prior to randomly selecting one or more items, for each of a second subset of items included in the plurality of items, additionally biasing selection of the item based on one or more of: the recency of the item and metadata associated with the item.

16. A social networking system for providing tips to users, the social network system comprising:
one or more processors;
system memory;
a tip database, the tip database containing one or more tips;
one or more computer storage devices having stored computer executable instructions representing a matching engine, the matching engine configured to:
access a plurality of tips from the tip database, each of the plurality of tips potentially being of interest to a user;
access a plurality of quality scores, each quality score in the plurality of quality scores corresponding to tip in the plurality of tips, each quality score indicative of a likelihood of a corresponding tip being of interest to the user;
for each of a subset of tips included in the plurality of tips, bias the chance of selecting the tip upward as a function of the corresponding quality score for the tip so as to increase the chance of selecting the tip during a random selection of tips; and
subsequent to biasing, randomly select one or more tips from among the plurality of tips for presentation to the user.

17. The social networking system of claim 16, further comprising a filter module, the filter module configured to, prior to biasing, filter out any tips that do not meet a specific quality threshold.

18. The social networking system of claim 16, further comprising a bias module, the bias module configured to further bias at least one tip based on the likelihood of the tip triggering a financial transaction.

19. The social networking system of claim 16, further comprising a filter module, the filter module configured filter out at least one tip based on one or more of: behavioral criteria and alternately derived quality scores.

20. The social networking system of claim 16, further comprising a filter module, the filter module configured filter out at least one tip based on metadata associated with the tip.
